(19) United States
(12) Patent Application Publication
(10) Pub. No.: US 2016/0249715 A1
(43) Pub. Date: Sep. 1, 2016

(54) MEDICAL CRUTCH

(71) Applicant: Jeffrey A. Hoogenboom, Moretown, VT (US)

(72) Inventor: Jeffrey A. Hoogenboom, Moretown, VT (US)

(21) Appl. No.: 15/152,669

(22) Filed: May 12, 2016

Related U.S. Application Data
(63) Continuation-in-part of application No. 13/965,097, filed on Aug. 12, 2013, now Pat. No. 9,358,177.

(51) Int. Cl. A45B 9/00; A61H 3/02

(52) U.S. Cl. CPC A45B 9/00; A61H 3/02; A45B 2009/007

(57) ABSTRACT

An elongated walking assistance device includes an upper portion, a lower portion, and an adjustable system which couples the upper and lower portions. The lower portion includes a shock absorbing system attached to a surface contact heel. The adjustable system includes a threaded rod which extends from the upper portion along a longitudinal axis, a pushbutton assembly surrounding the threaded rod, and a tubular shaft capturing the pushbutton assembly. For fine adjustments, the user may rotate the threaded rod with respect to the tubular shaft to adjust the overall length of the device. For coarse adjustments, the user may disengage the pushbutton and slide the tubular shaft along the longitudinal axis.

### CROSS REFERENCE TO RELATED APPLICATION

This non-provisional patent application is a continuation-in-part of and claims priority from U.S. Non-Provisional patent application Ser. No. 13/965,097 filed Aug. 12, 2013, which claims priority to U.S. Provisional Patent Application No. 61/681,689 filed Aug. 10, 2012, each of which is incorporated herein by reference.

### BACKGROUND OF THE INVENTION

The present disclosure relates to medical devices, and more particularly to medical crutches. Medical crutches are used in the medical field, often through the orthopedics department of a treatment facility. Medical crutches are often sold in the category of durable medical equipment (DME). Medical crutches can be used to support all or part of a patient's body weight. Medical crutches can be made of wood, metal, or other structural material. Medical crutches are typically configured to reach from a patient's underarm to a walking surface. Other configurations extend from the forearm, wrist area, hand, and the like.

Referring to FIG. 1, crutches 400 are usually configured to have a fixed-length frame 402 having an arm support 404 for placement under the arm, a handle 406 that extends horizontally between two support legs 408a, 408b to support the weight of a patient, and a surface contact heel 410 configured to contact the ground. The legs 408a, 408b have a plurality of holes 412 for adjusting the position of the handle 406, which is secured by wing nuts 414.

Shock absorbing devices, including springs, have been used with crutches 400 to lessen the impact to a patient as the body weight is transferred to the walking surface. Traditionally, these devices have been located in the upper portion of the crutches. Further, various adjustment mechanisms have been used to modify the length of medical crutches. These adjustment mechanisms are typically difficult to operate or do not provide the ability to fine tune overall crutch length to a specific desired length.

### SUMMARY

While various configurations have been attempted, there remains a need for an adjustable medical crutch having a shock absorbing device located on the lower portion of the crutch. There is also a need for a medical crutch that allows a user to easily adjust the overall length of the crutch to a specific desired length. The subject technology is equally applicable to other devices such as canes, walkers, forearm crutches, and walking sticks. The present disclosure preserves the advantages of existing medical crutches while providing new advantages not found in currently available medical crutches and overcoming many disadvantages of currently available medical crutches.

In one embodiment, the subject technology is directed to an elongated medical crutch. The crutch includes an upper portion with an arm support coupled to a handle, a lower portion with a shock absorbing system coupled to a surface contact heel, and an adjustable system. The adjustable system couples the upper portion and lower portion. The adjustable system includes a threaded rod extending from the upper portion along a longitudinal axis, a pushbutton assembly surrounding the threaded rod, and a tubular shaft capturing the pushbutton assembly and connecting the threaded rod and the lower portion. For fine adjustment of the overall length of the crutch, the threaded rod can be rotated with respect to the tubular shaft. For coarse adjustment of the overall length of the crutch, the pushbutton assembly can be actuated to disengage the pushbutton assembly from the threaded rod for sliding the tubular shaft linearly along the threaded rod. In one embodiment, the tubular shaft can define a tunnel along the longitudinal axis. Further, in one embodiment, the pushbutton assembly can include a main body having an axial bore and a transverse bore, a pushbutton extending through the transverse bore, and a spring, oriented between the pushbutton and main body to apply a force along the transverse axis.

Another aspect of the subject disclosure is directed to an elongated walking assistance device. The device includes an upper portion with a handle, a lower portion including with a shock absorbing system coupled to a surface contact heel, and an adjustable system. The adjustable system couples the upper portion and lower portion. The adjustable system includes a threaded rod extending from the upper portion along a longitudinal axis, a pushbutton assembly surrounding the threaded rod, and a tubular shaft capturing the pushbutton assembly. For fine adjustment of the overall length of the device, the threaded rod can be rotated with respect to the tubular shaft. For coarse adjustment of the overall length of the device, the pushbutton assembly can be actuated to disengage the pushbutton assembly from the threaded rod for sliding the tubular shaft linearly along the threaded rod. The elongated walking assistance device can be a cane, a walker, a forearm crutch, a walking stick, or any other walking assistance device. The pushbutton assembly can include a threaded push button. The tubular shaft of the device may define a tunnel along the longitudinal axis. The pushbutton assembly can also include a main body having an axial bore and a transverse bore, a pushbutton extending through the transverse bore, and a spring, oriented between the pushbutton and main body to apply a force along the transverse axis. The pushbutton can also have an axial bore with inner threads.

It should be appreciated that the subject technology can be implemented and utilized in numerous ways, including without limitation as a process, an apparatus, a system, a device, a method for applications now known and later developed. These and other unique features of the system disclosed herein will become more readily apparent from the following description and the accompanying drawings.

### BRIEF DESCRIPTION OF THE DRAWINGS

The novel features which are characteristic of the crutches are set forth in the appended claims. However, the crutch, together with further embodiments and attendant advantages, will be best understood by reference to the following detailed description taken in connection with the accompanying drawing Figures.

FIG. 1 is a side view of a prior art medical crutch.

FIG. 2 is a side view of a medical crutch in accordance with the subject technology.

FIG. 3 is a side view of another embodiment of a medical crutch in accordance with the subject technology.

FIG. 4A is a perspective view of a shock absorbing system in accordance with the subject technology.

FIG. 4B is a perspective view of a shock shaft, as in the shock absorbing system of FIG. 3 in accordance with the subject technology.

FIG. 4C is a perspective view of a connector, as in the shock absorbing system of FIG. 3 in accordance with the subject technology.

FIG. 5 is a perspective view of a shock absorbing system in accordance with the subject technology.

FIG. 6 is a side view of an adjustable system in accordance with the subject technology, shown disassembled for illustrative purposes.

FIG. 7 is a side view of an adjustable system in accordance with the subject technology.

FIG. 8A is a side view of a medical crutch with a pushbutton assembly in accordance with the subject technology.

FIG. 8B is an enlarged view of a portion of the adjustable system of FIG. 8A coupled to a threaded rod in accordance with the subject technology.

FIG. 9 is a perspective view of a pushbutton assembly of in accordance with the subject technology.

FIG. 10 is an exploded view of a pushbutton assembly in accordance with the subject technology

FIG. 11 is an exploded view of a tubular shaft and a pushbutton assembly in accordance with the subject technology.

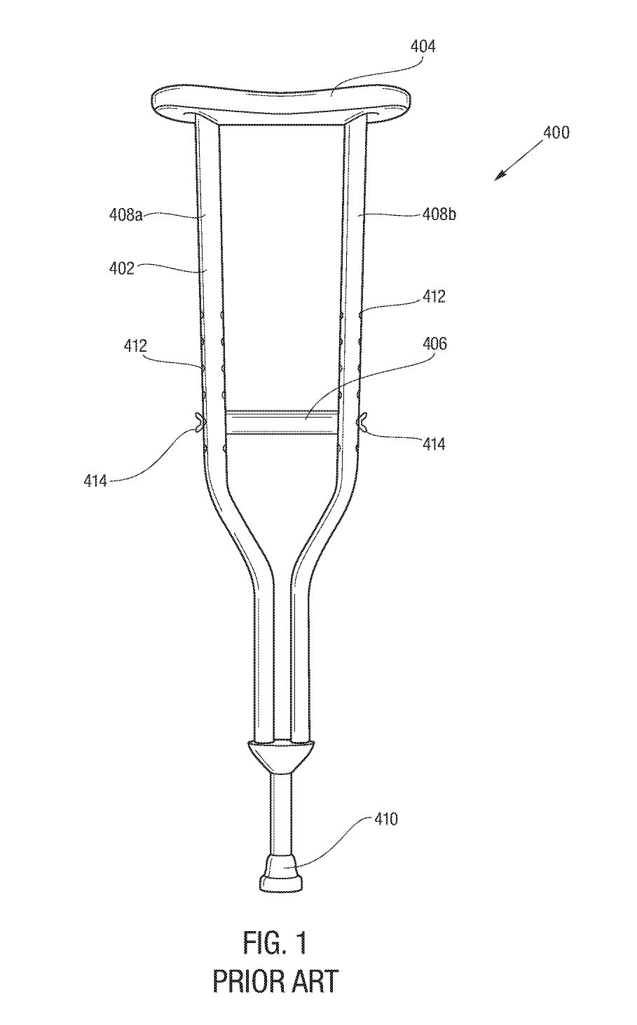

### DETAILED DESCRIPTION OF THE PREFERRED EMBODIMENTS

The subject technology overcomes many of the prior art problems associated with crutch shock absorber systems while providing the user with the ability to effectively adjust the length of the crutch. The advantages, and other features of the system disclosed herein, will become more readily apparent to those having skill in the art from the following detailed description of certain preferred embodiments taken in conjunction with the drawings which set forth representative embodiments of the present invention and wherein like reference numerals identify similar structural elements. It is understood that references to the figures such as up, down, upward, downward, left, and right are with respect to the figures and not meant in a limiting sense.

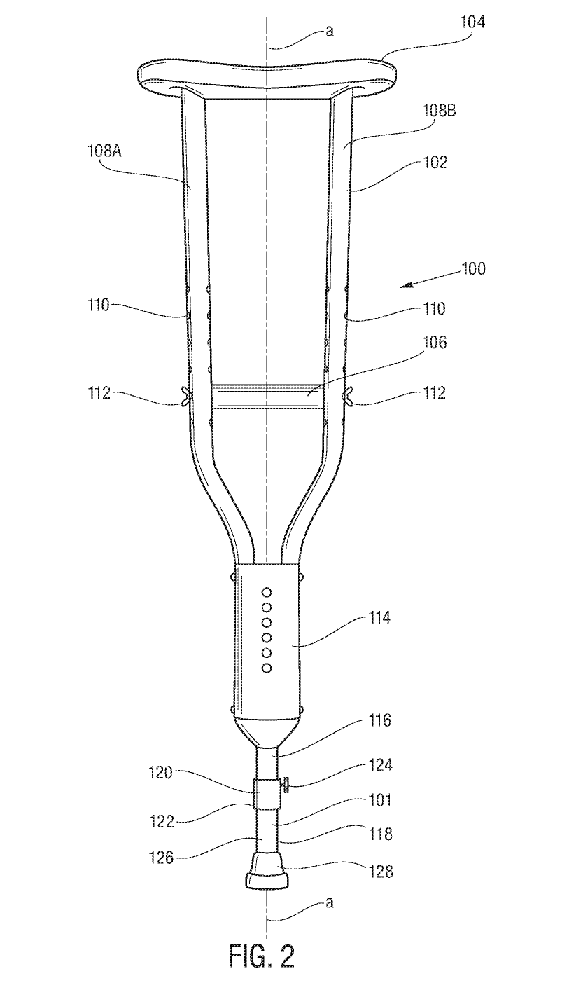

Referring now to FIG. 2, a side view of a medical crutch in accordance with the subject technology is shown generally by reference numeral 100. The crutch 100 includes an upper portion 102 having an arm support 104 for placement under the shoulder of a user or patient. A handle 106 extends horizontally between two support legs 108A, 108B for the patient to hold onto. The legs 108A, 108B have a plurality of holes 110 which allow the handle 106 to be secured to the legs 108A, 108B via wing nuts 112 at various locations. The upper portion 102 is coupled to an adjustable system 114 which allows the user to adjust the crutch length along the longitudinal axis “a” to achieve their desired length. The adjustable system 114 includes an adjustable shaft 116 which runs along the axis “a” and connects to a lower portion 101 inside an absorber coupler 120.

The lower portion 101 includes a shock absorbing system 118 which provides cushioning as a user shifts their weight onto the crutch 100, as well as a surface contact heel 128 which provides friction between the lower portion 101 and a ground surface. The shock absorbing system 118 includes a shock 122, housed within the absorber coupler 120. The resistance of the shock 122 can be adjusted by turning the shock adjuster 124. A shock shaft 126 extends from the lower end of the absorber coupler 122. The surface contact heel 128 is secured to the lower end of the shock shaft 126. In one embodiment, the arm support 104 and handle 106 are made of a soft material, such as rubber or a foam rubber coated material, while the other pieces are made of structural material such as anodized aluminum. One skilled in the art would recognize that alternatively, other materials which provide sufficient structural strength may be used. The medical crutch may also have additional components or features that are known in the prior art or a used with standard crutches.

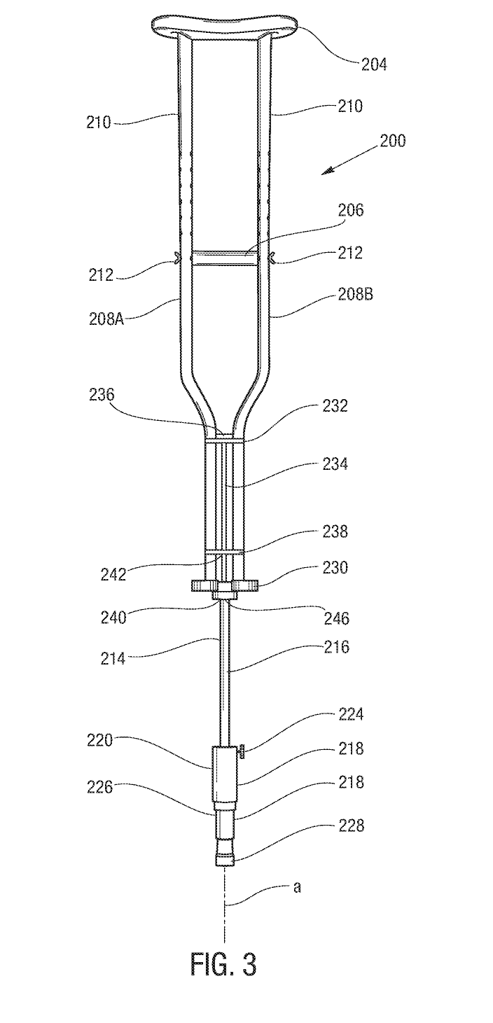

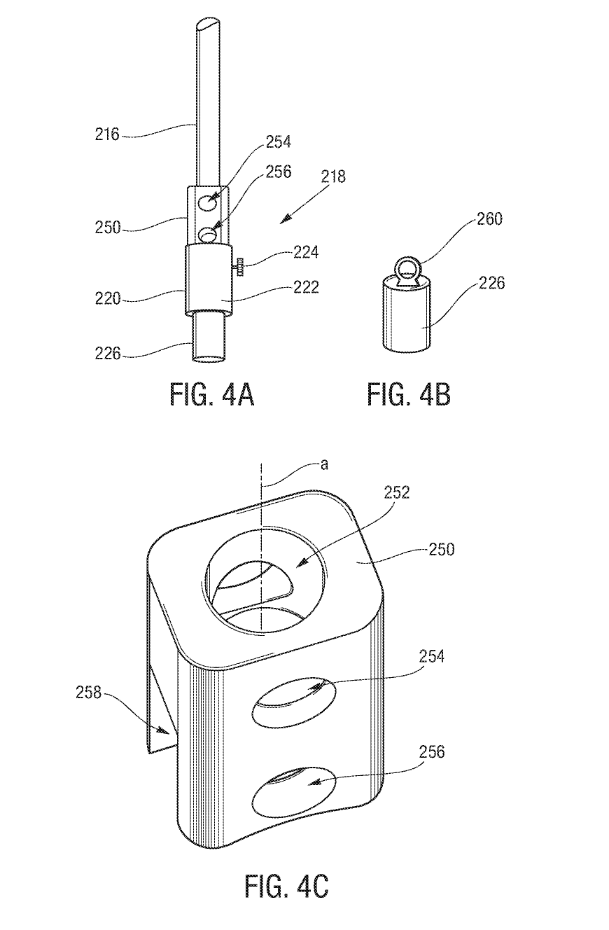

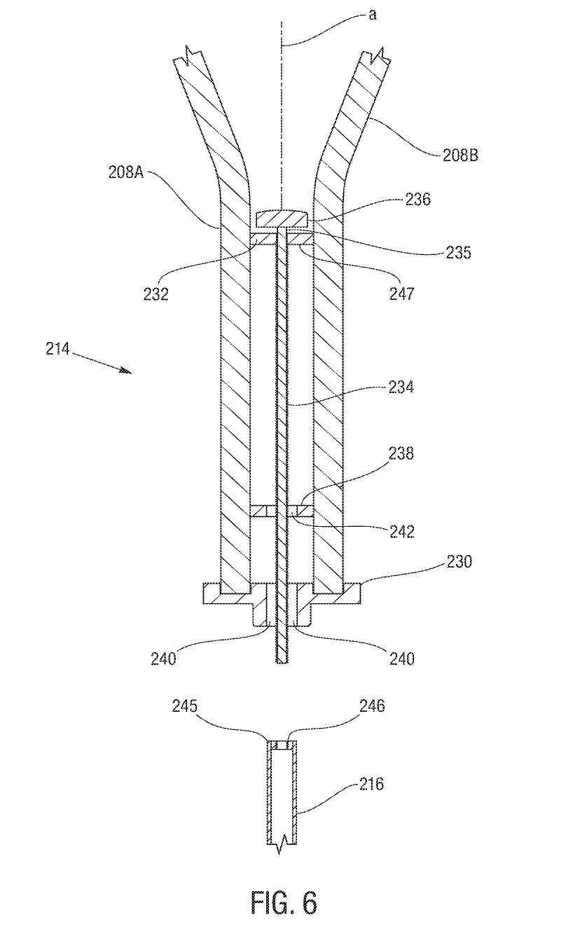

Referring to FIG. 3, a side view of another embodiment of a medical crutch in accordance with the subject technology is shown generally by reference numeral 200. The primary difference between the crutch shown in FIG. 2 and the crutch shown in FIG. 3 is the type of adjustable system shown. In FIG. 3, the crutch has an adjustable system of the type shown in FIG. 6, coupled to a shock absorbing system of the type shown in FIG. 4A.

Still referring to FIG. 3, the crutch 200 has support legs 208A, 208B which are affixed, at their lower end, to a frame coupler 230. The crutch has an adjustable system 214 which includes a top plate 232 that reaches between the support legs 208A, 208B. A threaded rod 234 is affixed, at its top end, to the top plate 232 by a nut 236. In other embodiments, the threaded rod 234 could be affixed to the top plate 232 by a set screw, spring pin, or the like. The threaded rod 234 extends along the longitudinal axis “a”, passing through the top plate 232 and a lower plate 238. The frame coupler 230 and lower plate 238 include a coupler tunnel 240 and lower plate tunnel 242, respectively, as depicted more clearly in FIG. 6, which allow the adjustable shaft 216 to move along the longitudinal axis “a”. The adjustable shaft 216 includes a threaded top end 246 which can engage the threaded rod 234. Thus, counter-clockwise rotation of the adjustable shaft 216 about the axis “a” forces the adjustable shaft 216 to move upward along the axis “a” with respect to the threaded rod 234. In this way, rotation of the adjustable shaft 216 around the longitudinal axis “a” results in an adjustment in the total length of the crutch 200. The user may adjust the length of the crutch 200 in this way to achieve a desired length based on their height and personal preferences. When the user has adjusted the crutch 200 length to reach a minimum length, the top 245 of the adjustable shaft 216 will come in contact with the bottom 247 of the top plate 232. Clockwise rotation of the shaft 216 moves the shaft 216 downward along the axis “a.” For stability, at a maximum overall length, the top 245 is still within the lower plate 238.

Referring now to FIG. 4A-4C, a shock absorbing system is shown generally at 218. The shock absorbing system 218 is configured for removable attachment to the adjustable shaft 216 via a connector 250. The connector 250 is configured for insertion into the absorber coupler 220, where it connects with a shock 222 housed within. The connector 250 includes an axial bore 252 for receiving the adjustable shaft 216. The connector 250 also includes an upper transverse bore 254 and a lower transverse bore 256. When the adjustable shaft 216 is inserted into the axial bore 252, a pin, threaded bolt, or the like may be inserted through the upper transverse bore 254 to affix the adjustable shaft 216 to the connector 250. The connector 250 also defines a lower gap 258. The lower gap 258 allows the connector 250 to slide over the top of a shock 222 such that a pin, threaded bolt, or the like may be inserted through the lower transverse bore 256 to affix the shock 222 to the connector 250. The shock shaft 226 includes a hook 260 to allow for fixation to the shock 222 within the absorber coupler 220.

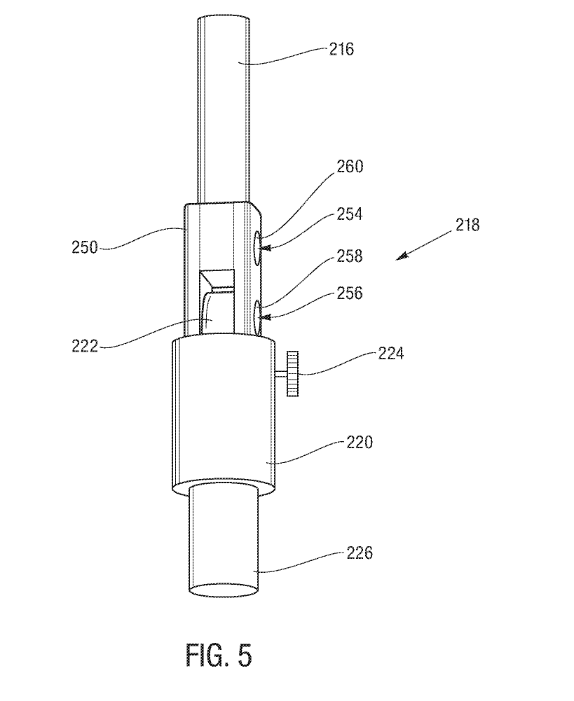

Referring now to FIG. 5, a perspective view of a shock absorbing system 218 is shown. A shock 222 is shown extending from the absorber coupler 220. The shock 222 is affixed to the connector 250 by a lower pin 258, which runs through the lower transverse bore 256. The connector 250 is affixed to the adjustable shaft 216 by an upper pin 260 which runs through the upper transverse bore 254. Within the absorber coupler 220, the shock shaft 226 is affixed to the shock 222 via the hook 260, shown in FIG. 4B.

The shock 222 provides a dampening means when the crutch is used. The shock 222 may be any of a variety of typical shock absorbers, such as a pneumatic shock absorber, an air over oil shock absorber, or the like. In one embodiment, a pneumatic shock is used which has an adjustable rebound control to modify the time it takes a plunger to return to the starting position. This adjustment may be made using the adjustment knob 224. In this way, the rebound control can be adjusted depending on the user's step speed. In one embodiment, the shock 222 also has an adjustable compression force, which is a dampening force based on the air pressure delivered into the shock 222 as a result of the user's weight. This adjustment can be accomplished by the adjustment knob 224, or any other similar adjustment mechanism. Thus, the user can easily adjust the compression distance and stiffness of the shock 222 depending on their step speed, body weight, and preferences. Alternatively, in another embodiment, the shock absorbing system 218 may include an air over oil shock which may operate at specific air pressure and includes an oil orifice inside that helps to maintain smooth movement of a piston inside of the shock.

Referring now to FIG. 6, a side view of the adjustable system 214 is shown disassembled for illustrative purposes. The threaded rod 234 is affixed, at its top end 235, to the top plate 232 by a nut 236. In other embodiments, the threaded rod 234 could be affixed to the top plate 232 by a set screw, spring pin, or the like. In the embodiment shown, the threaded rod 234 extends along longitudinal axis “a”, through the lower plate 238 and the frame coupler 230. The threaded rod 234 need not extend all the way through the frame coupler 230, and in other embodiments the threaded rod 234 extends to a location between the bottom of the lower plate 238 and frame coupler 230, for example. For illustrative purposes, the adjustable shaft 216 is shown separated from the threaded rod 234. The frame coupler 230 and the lower plate 238 include a coupler tunnel 240 and a lower plate tunnel 242, respectively, which allow the adjustable shaft 216 to move along the axis “a”. The adjustable shaft 216 includes a threaded top end 246 which can engage the threaded rod 234.

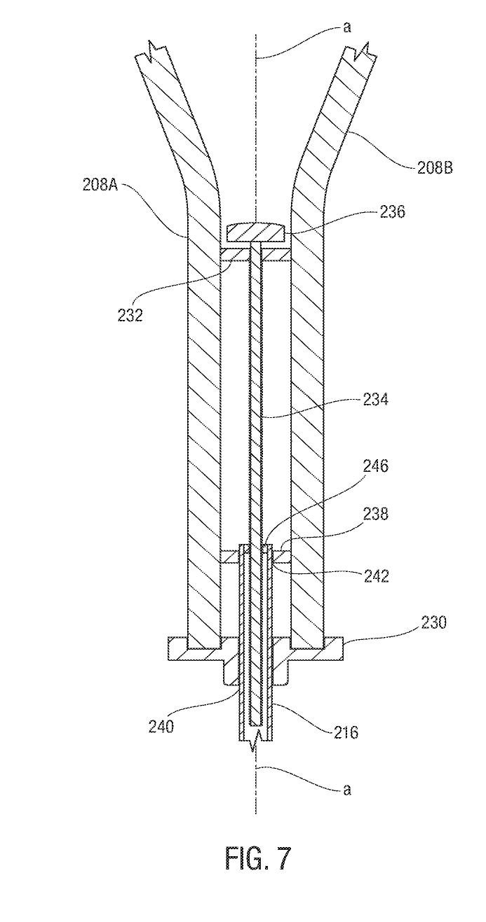

Referring now to FIG. 7, a side view of the adjustable system 214 is shown, adjusted to a position which would place the medical crutch very near a maximal overall length. The threaded top end 246 of the adjustable shaft 216 is shown engaging with the threaded rod 234. The adjustable shaft 216 has been rotated in the clockwise direction around the longitudinal axis “a”, causing the adjustable shaft 216 to move downward along the axis “a”. As the adjustable shaft 216 moves further downward along the axis “a”, the total length of the crutch is increased. In the position shown, the adjustable shaft 216 is shown barely penetrating the lower plate tunnel 242. Increasing the crutch length further, such that the adjustable shaft 216 no longer extends through the lower plate tunnel 242 runs the risk of potential instability.

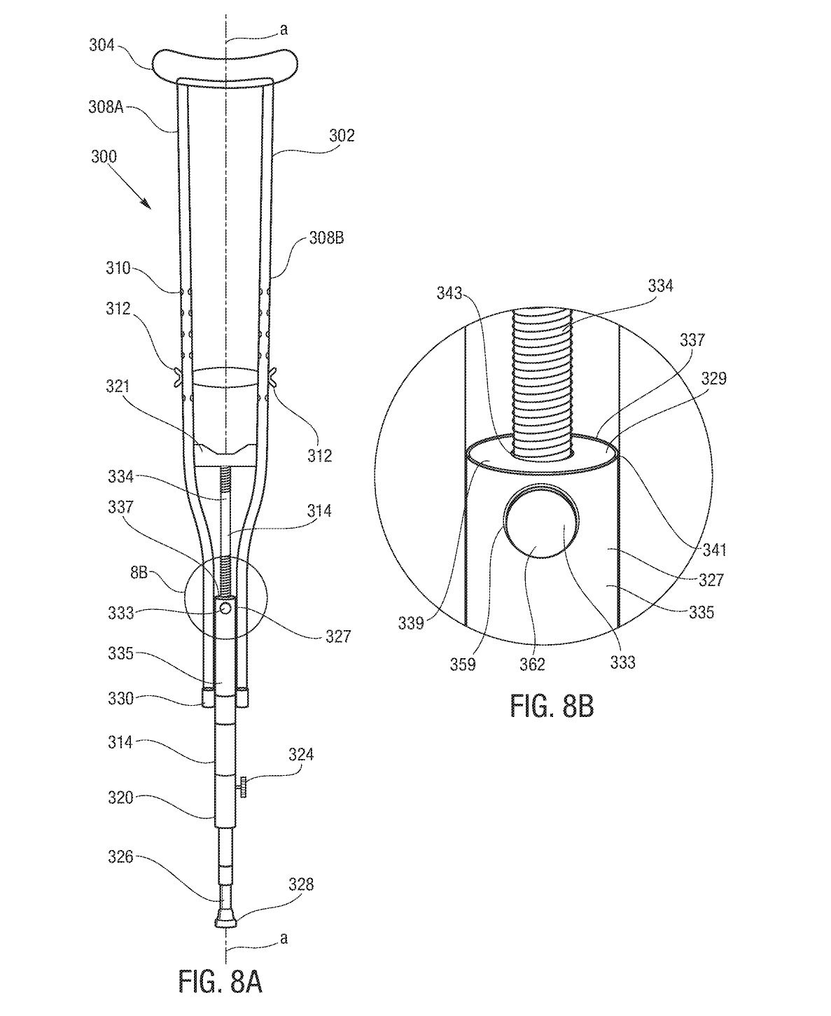

Referring to FIG. 8A, a side view of a medical crutch with an adjustable system in accordance with the subject technology is shown generally by numeral 300. Similar elements to those described in connection with the above-described embodiments are indicated with like reference numbers. Many elements are essentially the same as those of the foregoing embodiments and, thus, are not further described herein. The primary difference is that in this embodiment the adjustable system 314 includes a pushbutton assembly 327 that allows for quick and easy large adjustments as well as fine adjustments. The adjustable system 314 also includes a tubular shaft 335 which defines an axial tunnel 337 and retains the pushbutton assembly 327. The threaded rod 334 is affixed to the upper portion 302 of the crutch 300 by a support plate 321 which extends between the legs 308A, 308B.

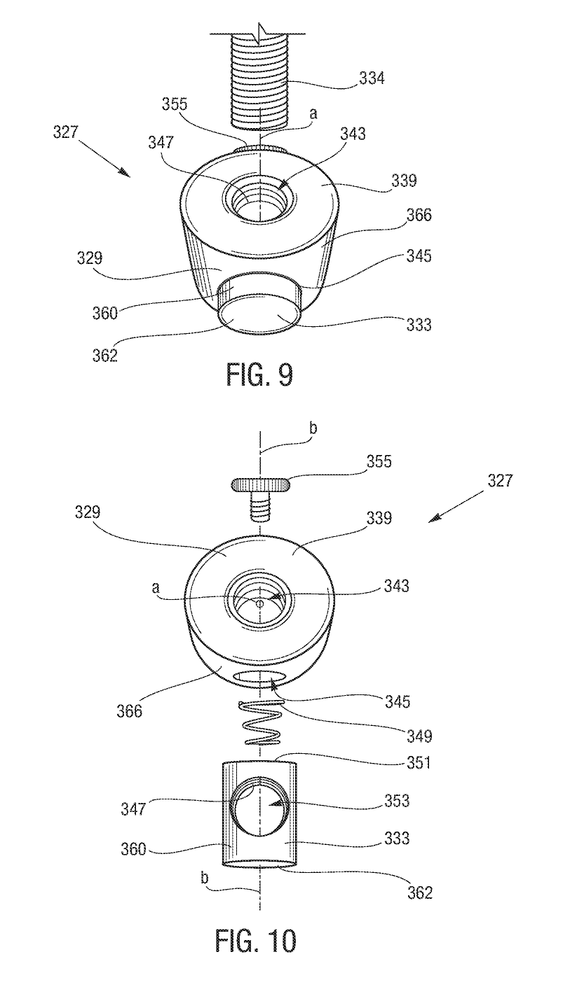

Referring now to FIG. 8B, an enlarged view of a portion of the adjustable system of FIG. 8A is shown. The pushbutton assembly 327 has a main body 329 which includes an axial bore 343 for receiving the threaded rod 334. The main body 329 has an upper surface 339 flush with the top end 341 of the tubular shaft 335. The pushbutton assembly 327 also includes a pushbutton 333 which can be depressed to disengage the threaded rod 334, as depicted in FIGS. 9-10, allowing for large adjustments in the length of the crutch 300. The pushbutton assembly 327 is secured to the tubular shaft 335 with the pushbutton 333 locked into a transverse bore 359 in the tubular shaft 335.

Referring now to FIGS. 9-10, the pushbutton assembly 327 is shown. The pushbutton assembly 327 includes a main body 329 which has an axial bore 343 for receiving the threaded rod 334 and a transverse bore 345 for receiving the pushbutton 333. The transverse bore 345 couples to the outer surface 360 of the pushbutton 333. The pushbutton 333 is biased such that the proximal end 362 of the pushbutton 333 protrudes from the transverse bore 345 of the main body 329. A spring 349 is located between the distal end 351 of the pushbutton 333 and the main body 329. The spring 349 applies force along the transverse axis “b”, resisting actuation of the pushbutton 333. The pushbutton 333 has an axial bore 353 of an inner diameter large enough to receive the threaded rod 334. The axial bore 353 may be formed by drilling an oval bore, two overlapping bores, or one bore of a larger diameter than the threaded rod 334. When assembled, the axial bore 353 of the pushbutton 333 generally aligns with the axial bore 343 of the main body 329, and the threaded rod 334 extends through both axial bores 343, 353 along the longitudinal axis “a.” The axial bore 353 of the pushbutton 333 has inner threads 347 on the side nearest the distal end 351 which, when assembly, mesh with the threaded rod 334 to resist movement along the longitudinal axis “a.” Additionally, a set screw 355 passes through the main body 329 on the side opposite the transverse bore 345. When the set screw 355 is tightened, it applies force to the distal end 351 of the pushbutton 333. Thus, when a threaded rod 334 is inserted through the axial bores 343, 353, tightening the set screw 355 causes the inner threads 347 of the pushbutton 333 to mesh tightly with the threaded rod 334. In this way, when the set screw 355 is tight, the inner threads 347 will prevent the threaded rod 334 from moving, with respect to the pushbutton assembly 327, along the longitudinal axis “a.” On the other hand, when the set screw 355 is loose, the proximal end 362 of the pushbutton 333 may be pressed in along the transverse axis “b” to allow the threaded rod 334 to slide freely along the longitudinal axis “a.”

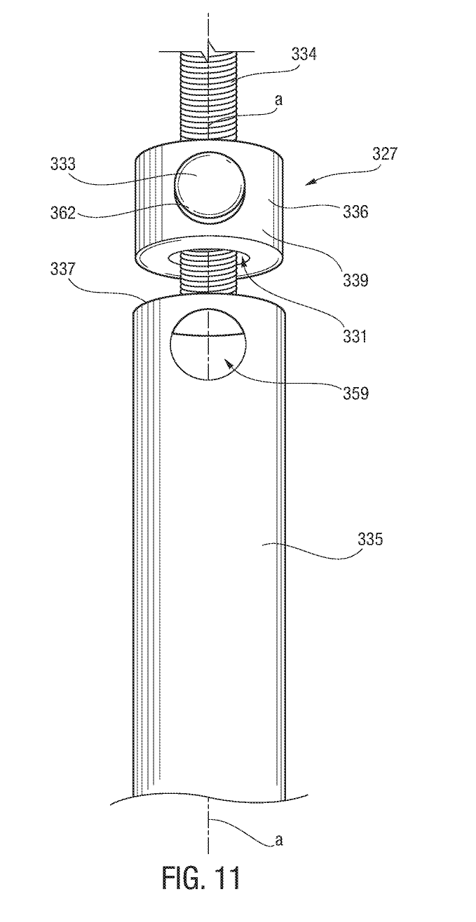

Referring now to FIG. 11, an exploded view of the tubular shaft 335 and the pushbutton assembly 327 in accordance with the subject technology are shown. The tubular shaft 335 defines an axial tunnel 337 which runs along the longitudinal axis “a.” The pushbutton assembly 327 has a main body 329 with an outer surface 366. The outer surface 366 has a diameter which allows the main body 329 to slide into the axial tunnel 337. When assembled, the main body 329 is housed within the axial tunnel 327 and the pushbutton 333 protrudes from the transverse bore 359, as depicted in FIG. 8B.

Referring now to FIGS. 8A-8B, the pushbutton assembly 327 allows the user to make both fine and coarse adjustments. The pushbutton assembly 327 is retained within the axial tunnel 337 of the tubular shaft 335. The user may depress the proximal end 362 of the pushbutton 333 to disengage the threaded rod 334, allowing the tubular shaft 335 and pushbutton assembly 327 to slide along the longitudinal axis “a.” In this way, the user may depress the pushbutton 333 to carry out large adjustments in the overall length of the crutch 300. When the user has reached their desired position, the user can release the pushbutton 333 and the inner threads 347 of the pushbutton 333 will then engage with the threads of the threaded rod 334. After large adjustments are made in this fashion, the user may twist the tubular shaft 335 around the threaded rod 334, with respect to the longitudinal axis “a”, to make fine adjustments in the overall length of the crutch 300. When a desired length is obtained, the set screw 355 is then tightened on the opposite side of the pushbutton 333, as shown in FIG. 12, to apply pressure on the pushbutton 333 and maintain a tight locking fit of the pushbutton assembly 327 to the threaded rod 334. The user can then operate the crutch 300.

It would be appreciated by those skilled in the art that various changes and modifications can be made to the illustrated embodiments without departing from the spirit of the present disclosure. All such modifications and changes are covered by the appended claims.

What is claimed is:

1. An elongated medical crutch comprising:
an upper portion including: an arm support coupled to a handle;
a lower portion including: a shock absorbing system coupled to a surface contact heel; and
an adjustable system coupling the upper portion and lower portion, said system including: a threaded rod extending from the upper portion along a longitudinal axis; a pushbutton assembly surrounding the threaded rod; and a tubular shaft capturing the pushbutton assembly and connecting the threaded rod and the lower portion.
wherein: for fine adjustment, rotation of the threaded rod with respect to the tubular shaft adjusts an overall length of the crutch; and
for coarse adjustment, the pushbutton assembly is actuated to disengage the pushbutton assembly from the threaded rod for sliding the tubular shaft linearly along the threaded rod.

2. An elongated medical crutch as recited in claim 1, wherein: the tubular shaft defines a
tunnel along the longitudinal axis; and
the pushbutton assembly includes: a main body having an axial bore and a transverse bore; a pushbutton extending through the transverse bore; and a spring, oriented between the pushbutton and main body to apply a force along the transverse axis.

3. An elongated walking assistance device comprising:
an upper portion including a handle;
a lower portion including: a shock absorbing system coupled to a surface contact heel; and
an adjustable system coupling the upper portion and lower portion, said system including: a threaded rod extending from the upper portion along a longitudinal axis; a pushbutton assembly surrounding said threaded rod; and a tubular shaft capturing the pushbutton assembly,
wherein: for fine adjustment, rotation of the threaded rod with respect to the tubular shaft adjusts an overall length of the device; and
for coarse adjustment, the pushbutton assembly is actuated to disengage the pushbutton assembly from the threaded rod for sliding the tubular shaft linearly along the threaded rod.

4. An elongated walking assistance device as recited in claim 3, wherein the elongated walking assistance device is a cane.

5. An elongated walking assistance device as recited in claim 3, wherein the elongated walking assistance device is a walker.

6. An elongated walking assistance device as recited in claim 3, wherein the elongated walking assistance device is a forearm crutch.

7. An elongated walking assistance device as recited in claim 3, wherein the elongated walking assistance device is a walking stick.

8. An elongated walking assistance device as recited in claim 3, wherein the pushbutton assembly includes a threaded push button.

9. An elongated walking assistance device as recited in claim 3, wherein: the tubular shaft
defines a tunnel along the longitudinal axis; and
the pushbutton assembly includes: a main body having an axial bore and a transverse bore; a pushbutton extending through the transverse bore; and a spring, oriented between the pushbutton and main body to apply a force along the transverse axis.

10. An elongated walking assistance device as recited in claim 9, wherein the pushbutton has an axial bore with inner threads.
